(19) United States
(12) Patent Application Publication
(10) Pub. No.: US 2026/0187879 A1
(43) Pub. Date: Jul. 2, 2026

(54) SEMANTIC LEVEL OF DETAIL FOR CONTENT

(71) Applicant: GOOGLE LLC, Mountain View, CA (US)

(72) Inventors: Jonathon Buckley, Seattle, WA (US); Alex Olwal, Santa Cruz, CA (US); Boris Smus, Seattle, WA (US)

(21) Appl. No.: 19/429,483

(22) Filed: Dec. 22, 2025

Related U.S. Application Data
(60) Provisional application No. 63/740,189, filed on Dec. 30, 2024.

(51) Int. Cl. G06T 11/60; G06F 3/0484; G06F 3/16; G06F 40/30; G10L 17/06

(52) U.S. Cl. CPC G06T 11/60; G06F 3/167; G06F 40/30; G06F 3/0484; G06T 2200/24; G06T 2210/36; G10L 17/06

(57) ABSTRACT

A method including identifying a plurality of entities associated with a location within a physical environment, generating a representation for a subset of the plurality of entities based on a feature of the entities included in the subset, and causing a user interface, including the representation, to be rendered on a display of a wearable device.

### CROSS REFERENCE TO RELATED APPLICATION

This application claims the benefit of U.S. Provisional Application No. 63/740,189, filed Dec. 30, 2024, the disclosure of which is incorporated herein by reference in its entirety.

### BACKGROUND

Computer graphics systems often include tools that allow for the efficient rendering of geometry and information within a digital scene. A common technique is level-of-detail (LOD) management, where the complexity of graphical representations is adjusted based on factors such as the viewpoint or zoom level. For example, the geometric detail of a 3D model can be reduced as it moves farther from the virtual camera, which helps maintain interactive frame rates in complex environments. This principle ensures that computational resources are focused on the most visually significant elements in a scene.

Beyond geometric data, user interfaces frequently display informational entities such as labels, icons, or textual annotations that are associated with objects or locations within a two-dimensional or three-dimensional space. This informational layer provides context and surfaces relevant data to the user. The presentation and management of this information are fundamental aspects of user interface design, particularly in data-rich applications like digital maps, collaborative design tools, and data visualization dashboards. These systems must balance the need to convey comprehensive information with the goal of maintaining a clear and understandable display.

### SUMMARY

When rendering information objects, the density of these informational objects can exceed the capacity of the display, leading to a cluttered and illegible interface. This issue is particularly acute on devices with limited screen area, such as smartwatches and wearable glasses, or in zoomed-out views of large datasets. Some implementations describe a technique of semantic summarization to address this information density problem. Instead of treating informational objects as simple graphical objects to be rendered or hidden, the system analyzes their underlying meaning or semantics (e.g., a document's topic, a song's genre, or a conversation's subject matter). The system can then cluster objects that share common semantic features and generate a single, summarized representation for each cluster. For example, in a large folder, a long list of filenames might be replaced by a summary. Similarly, on a collaborative digital whiteboard, a dense group of individual notes could be represented by a single label. This approach provides a dynamic level of detail based on meaning, allowing a user to interact with the summarized representations to zoom in and explore the underlying details.

In a general aspect, a device, a system, a non-transitory computer-readable medium (having stored thereon computer executable program code which can be executed on a computer system), and/or a method can perform a process with a method including receiving a request for a representation associated with a location, identifying a plurality of points of interest associated with the location, identifying a subset of the plurality of points of interest based on at least one criterion corresponding to at least one feature associated with the plurality of points of interest, and causing a user interface, including the representation associated with the location and the subset, to be rendered on a display of a wearable device.

In another general aspect, a device, a system, a non-transitory computer-readable medium (having stored thereon computer executable program code which can be executed on a computer system), and/or a method can perform a process with a method including identifying a plurality of entities associated with a location within a physical environment, generating a representation for a subset of the plurality of entities based on a feature of the entities included in the subset, and causing a user interface, including the representation, to be rendered on a display of a wearable device.

### BRIEF DESCRIPTION OF THE DRAWINGS

Example implementations will become more fully understood from the detailed description given herein below and the accompanying drawings, wherein like elements are represented by like reference numerals, which are given by way of illustration only and thus are not limiting of the example implementations.

FIG. 1A illustrates a pictorial diagram of a physical environment according to an example implementation.

FIG. 1B illustrates another pictorial diagram of a physical environment according to an example implementation.

FIG. 2 illustrates a mapping user interface according to an example implementation.

FIGS. 3A, 3B, 3C, 3D, and 3E illustrate a mapping user interface according to an example implementation.

FIG. 4 is a block diagram of a data structure and a data flow according to at least one example implementation.

FIG. 5 is a block diagram of a method of displaying data associated with a location (or representation associated with a location) according to an example implementation.

FIG. 6 is a block diagram of a method of generating a map for a location (or representation associated with a location) according to an example implementation.

FIG. 7 is a block diagram of a method of generating a representation for a location according to an example implementation.

It should be noted that these Figures are intended to illustrate the general characteristics of methods, and/or structures utilized in certain example implementations and to supplement the written description provided below. These drawings are not, however, to scale and may not precisely reflect the precise structural or performance characteristics of any given implementation and should not be interpreted as defining or limiting the range of values or properties encompassed by example implementations. For example, the positioning of modules and/or structural elements may be reduced or exaggerated for clarity. The use of similar or identical reference numbers in the various drawings is intended to indicate the presence of a similar or identical element or feature.

### DETAILED DESCRIPTION

The systems and techniques described herein can solve problem of visual clutter when displaying a large amount of information in a limited space. This is particularly challenging for mapping applications on mobile devices or in augmented reality, where dozens of points of interest can overlap and become unreadable. The described solutions use a process called semantic summarization, which goes beyond simply hiding icons. It analyzes the meaning of the underlying information and groups similar items into logical clusters. Some implementations describe an intelligent summarizer for dense information, giving a user the substance of what's available so the user can choose where to focus their attention. For example, a user can look at a map of a busy downtown area on a small device (e.g., wearable device, mobile phone, and the like) display while searching for a place to eat. A standard map would be cluttered with dozens of overlapping icons, making it impossible to understand the options. Some implementations, however, would analyze the type of each place and replace the clutter with clean, summarized labels like “8 Italian Restaurants,” “5 Cafes,” and “4 Sushi Places.” This provides an immediate, high-level overview. If the user is interested in Italian food, they can interact (e.g., tap or gaze) that summary to zoom in and see the details of the individual restaurants, such as their specific locations, ratings, and price ranges.

The same principle applies to other types of entities within a physical environment, not just visual points of interest. For example, a user wearing smart glasses can enter a crowded reception where a plurality of entities, in this case multiple conversation groups, are happening simultaneously. Instead of being overwhelmed, the system can generate a representation for a subset of the plurality of entities based on a feature of those entities. For example, a summarized representation, such as a floating text label, can be generated based on the topic of each discussion (e.g., semantic feature). Labels like “Topic: Technology,” “Topic: Sports,” and “Topic: Travel” can be rendered on a display of the wearable device, positioned near each group of speakers. The user can then interact with a representation to explore the underlying entity in more detail.

An entity can refer to any identifiable object or phenomenon associated with a location, including transient or non-physical ones. Other examples of entities can include distinct sound sources in a noisy environment, groups of annotations on a digital whiteboard, or even clusters of people in a public space. A feature, in this context, can be a characteristic or property derived from an entity that can be used for summarization. For a conversation entity, the feature could be its topic, its sentiment (e.g., heated debate), or the primary language being spoken. For a sound source entity, the feature could be its classification (e.g., music, siren, speech). This flexibility allows the system to summarize a wide variety of information types.

In other words, the described technology can transform an overwhelming amount of data, whether visual points on a map or simultaneous audio streams, into a structured and easily navigable summary, allowing the user to understand an environment at a glance and explore details on demand. This approach can provide a dynamic level of detail based on meaning, allowing a user to interact with the summarized representations to zoom in and explore the underlying details.

In some implementations, this technology can be applied where the location is a digital information space, such as an infinite canvas-style collaborative tool (e.g., a digital whiteboard or design software). For example, the plurality of entities can be digital assets within that space, such as individual sticky notes, images, or design components. A representation can be generated for a subset of these assets based on a shared feature. For example, the system can analyze the text on multiple sticky notes and determine that the shared feature is a topic related to, for example, “Q4 Planning”. The system can be configured to generate a single summary representation, such as a label reading “Q4 Planning Notes”, to replace the individual digital assets, thereby simplifying the view of the digital information space.

In some implementations, a digital information space is not limited to a visual canvas. For example, a digital information space can be any non-physical environment containing data, such as a file system, a code repository, or a media database. Digital assets can be individual items within that space, such as files, code functions, or songs in a playlist. While in some implementations the feature is a topic, this is just one example of a semantic feature. Alternative features for digital assets could include the file type, creation date, author, or a visual characteristic (e.g., the color of sticky notes), and/or the like.

At least one technical problem can arise when rendering a representation of a location on a wearable device (e.g., smart glasses or a smartwatch) or other mobile device with limited display area. The limited display area, or screen real estate, of such devices can result in a design philosophy centered on simplification and prioritization, as it is often impossible to show everything. The degree of summarization required for a wearable device is a bigger order of magnitude than for a larger screen like a computer monitor or a tablet. For example, a view might be simplified to show only two or three summarized results instead of ten. The technical problem is that a direct representation of all available points of interest results in a cluttered, illegible, and ultimately unusable interface, overwhelming a view of the user. A common but inadequate solution is to simply omit information or display a small, arbitrary subset, which fails to provide the user with a comprehensive or meaningful overview of the available information.

For example, in some cases a map region can include a large quantity of points of interest, such as restaurants, shops, and services. A technical problem with existing mapping programs is that a device display cannot show all of the points of interest in a way that is useful to a user on a small form factor display and/or on other displays at wider zoom levels where the map becomes cluttered and illegible. A typical solution is for the mapping user interface to select a few points of interest to display or highlight. This approach, however, may not be useful to the user because the points of interest displayed may not provide an adequate overview of what the area has available, potentially omitting information that is relevant to the user's needs.

This technical problem is not limited to traditional two-dimensional maps. For a user wearing a wearable device with a transparent display (e.g., smart glasses), the representation associated with a location can be an augmented reality overlay on their direct view of the physical world. In this context, the challenge of information density can be more critical, as visual clutter can obscure the user's view of their surroundings and create a distracting or unsafe experience. Therefore, a technical solution is needed to intelligently present a relevant subset of information about the points of interest within the user's field of view.

At least one technical solution can address this problem with a method that begins by identifying a subset of the plurality of points of interest based on at least one criterion corresponding to at least one feature associated with those points. For example, the system can analyze a semantic feature of each point of interest, such as its business category. The system can then apply a criterion, such as grouping all points of interest that share the same category. The user interface then renders this identified subset by, for example, generating a single, summarized representation for the group that replaces the individual items on the display, such as a label reading 5 Cafes.

In some implementations, a feature can be understood as an attribute or metadata associated with a point of interest. For example, for a restaurant, features could include its cuisine type (Italian), price range ($$), or user rating (4 stars). A criterion, in turn, can be a rule or condition applied to these features for grouping. An example criterion would be the feature “cuisine type” must be “Italian”. The process of identifying a subset can include applying this criterion to the plurality of points of interest to identify members that satisfy the criterion, thereby forming a logical grouping (the subset) for summarized display.

In some implementations, the process of clustering or grouping points of interest can include first converting their semantic features into a numerical format, such as feature vectors. This conversion process, known as feature engineering, handles different data types. For example, categorical data like ‘cuisine type’ (‘Italian,’ ‘Sushi’) can be converted into a binary format using one-hot encoding, where each category becomes a separate dimension in the vector. Numerical features, such as ‘user rating’ (e.g., 4.5 stars) or ‘price range’ (e.g., ‘$$’ converted to 2), can be normalized to a consistent scale (e.g., 0 to 1) and included directly. For more complex semantic features derived from unstructured text, such as topics from conversation transcripts or themes from user reviews, the system can employ natural language processing techniques like word embeddings or sentence transformers to generate dense vector representations that capture the underlying meaning. The system can then apply a clustering algorithm, such as k-means or DBSCAN, to these vectors. The algorithm can group points of interest that are close to each other in the multi-dimensional feature space, effectively clustering entities with similar properties. The output of this algorithm can be one or more identified subsets, each corresponding to a distinct cluster.

To make the summarized subsets useful, the system can be configured to generate an interface for interacting with the subset. For example, a graphical control element can indicate the subset on the graphical user interface. For example, the summarized representation (e.g., “3 Cafes”) itself can act as a graphical control element. The system can be configured to generate an interface for interacting with this element, such as allowing the user to tap or select it. This interaction can expand the subset to reveal the individual points of interest within it, thus allowing the user to zoom in semantically and explore details on demand.

In addition to grouping points of interest, a further aspect of the technical solution can include an initial filtering step. Before or during the process of identifying subsets for summarization, the system can first identify at least one of the plurality of points of interest as a point of interest lacking relevance to the user's current context. These irrelevant points can be removed from the plurality of points of interest that are considered for display. This pre-filtering step further reduces information density and ensures that the summarized representations can be generated from a pool of genuinely useful options.

In some implementations, a representation can refer to a data object (e.g., a graphical or textual element) that can be generated by a system to stand for a subset of other entities. A representation can provide a simplified or summarized view. In some implementations, a representation can be any user interface element that is created as a result of a clustering process, which serves as a high-level summary of a group of entities and may act as an interactive control for accessing the underlying entities. In some implementations, a representation can be the output of a summarization algorithm, which can take the form of a quantitative label, a natural language description, or another graphical element, and is rendered on a display in place of a plurality of individual entities.

In some implementations, a digital asset can refer to any discrete, identifiable data object within a digital information space that can be individually selected, manipulated, or associated with metadata. In some implementations, a digital asset can be any item within a non-physical environment, such as a file, a note, a design component, or a media item, that the system can process as a distinct entity for the purpose of clustering and summarization. In some implementations, a digital asset can be an individual component within a digital workspace or data structure that has one or more features that can be analyzed by a system to determine its relationship to other assets.

In some implementations, a language processing model, a model configured to process language, and/or natural language processing can refer to a field of artificial intelligence and computer science focused on enabling computers to understand, interpret, and derive meaning from human language. In some implementations, a language processing model, model configured to process language, and/or natural language processing can be a computational technique for analyzing text or speech to extract structured information, such as topics, entities, sentiment, or user intent, from unstructured linguistic data. In some implementations, a language processing model, model configured to process language, and/or natural language processing is any set of algorithms or models used by a system to process transcribed speech or text to determine a semantic feature that can be used for clustering or summarization.

In some implementations, source localization can refer to the process of determining the spatial origin of a signal (e.g., a sound wave, relative to a set of sensors, and the like). In some implementations, source localization can be a computational method that analyzes the differences in a signal's properties (e.g., time of arrival, intensity, and the like) across a microphone array to calculate the direction or position of a sound source in a physical environment. In some implementations, source localization is any algorithm used by the system to distinguish between a plurality of speakers by identifying the physical location from which their speech originates.

While in some implementations automatically removing irrelevant points is effective, another implementation can include direct user interaction. After identifying a point of interest as potentially lacking relevance, the system can query (e.g., provide an indication of a question) the user what to do with that point of interest. This approach can be configured to provide the user with greater control, as the system's automated determination of relevance may not always align with the user's specific, momentary intent. For example, a user might still want to see closed restaurants to plan for another day or view inaccessible points of interest out of general curiosity. By prompting the user, the system can avoid making a potentially undesirable filtering decision on their behalf.

In addition to graphical or prompt-based interactions, the system can be configured to receive and process voice commands. This hands-free control of interaction can be a technical advantage for wearable devices where manual input may be difficult or unsafe. A user can speak a command in natural language to dynamically filter the entities being displayed, allowing for more fluid and intuitive control over the information presented in the user interface.

A further technical solution can include making the summarization process proactive and predictive. The system can be configured to access and identify various sources of user context data to tailor the summaries in a way that anticipates the user's needs, rather than reacting to direct commands. This can allow the system to generate representations that are not only semantically relevant to the entities themselves, but also contextually relevant to the user's current situation.

For example, a technical solution can be to implement this semantic processing technique to use a language processing model, model configured to process language, and/or natural language processing to generate new representations of the information associated with a location. Instead of displaying individual points of interest, this technique can process semantic data or labels for each point of interest (e.g., type, cuisine, or price range) to identify and cluster similar entities. For example, numerous restaurant icons could be replaced with a single, summarized graphical element representing a set of restaurants or more specifically a subset of Italian restaurants.

At least one technical effect of the technical solution is that the solution provides the user with a more intuitive and useful overview of the information to be displayed. For example, this approach to presenting information provides the user with a more intuitive and useful overview of the area's offerings, reducing map clutter while surfacing the underlying properties of the physical space.

Some implementations can use semantic analysis and summarization by leveraging advanced artificial intelligence, particularly large language models (LLMs). While the implementations can include clustering entities based on predefined semantic labels like “restaurant type” or “cuisine,” the integration of an LLM can elevate this process from simple categorization to a nuanced, context-aware understanding. In some implementations, the LLM can process vast amounts of unstructured and structured data associated with an informational entity and/or object, enabling an interpretation of the informational object's meaning and relevance.

For example, in the map use case, a model can be configured (e.g., trained) to analyze not only the explicit category of a point of interest but also the sentiment and key themes within user reviews, descriptions, and associated web content. This can allow for the creation of summaries that are more aligned with human intent. Instead of grouping restaurants as “Italian,” the model can be configured to generate dynamic, context-sensitive clusters like “Well-rated spots for a date night,” “Family-friendly and affordable,” or “Quick lunch options nearby.” This moves beyond data clustering to provide actionable insights.

Some implementations can include fine-tuning the LLM on a curated dataset that pairs lists of points of interest with their desired qualitative descriptions. Another implementation can be configured to use advanced prompt engineering, where the system provides the LLM with a detailed prompt that includes not only the data for the entities but also the user's current context and a specific persona to adopt (e.g., “You are a local tour guide. Based on the following restaurant reviews and the user's request for a date night spot, generate a descriptive category for this group of restaurants.”). The LLM can then synthesizes this information to generate a context-sensitive cluster name.

This generative capability is also transformative for the summarized representations themselves. Rather than displaying a static, numerical label like “7 Restaurants,” the system can use an LLM to synthesize a natural language summary. This can be achieved by constructing a prompt for the LLM that includes the list of entities in the identified subset along with their key features (e.g., names, categories, and key themes from user reviews). The prompt can instruct the LLM to generate a concise, human-readable summary based on the shared characteristics. For a cluster of shops, the LLM might generate, for example, “A group of high-end boutiques known for designer clothing.” For conversations, the LLM might generate, for example, “A lively discussion about recent advances in AI.” This makes the user interface more intuitive and conversational, providing the substance of the information in a way that feels more like a helpful assistant and less like a rigid data filter.

In the auditory environment application, an LLM can be well-suited for processing the complexities of human speech associated with each conversation entity. After transcription, the model can analyze the text to identify not just a single high-level topic but a set of features, including sentiment, key arguments, and named entities. This enables the generation of more descriptive representations. A representation could thus evolve from a “Topic: Technology” to a more insightful, for example, “Debate about the ethics of autonomous vehicles,” which is generated based on a feature (or features) derived from that conversation entity, allowing a user to more accurately gauge interest.

The system can implement this proactive capability by first identifying user context data, wherein the user context data includes at least one of a calendar event, a time of day, or a user location history. For example, the system can access the user's calendar and identify an upcoming meeting scheduled in 30 minutes. The system can then proceed by determining the feature(s) of the entities based on the user context data. Instead of using a static feature like business type, the system can be configured to dynamically determine a context-relevant feature, such as service speed, for the nearby cafe entities. Finally, the system can be configured to generate the representation as a natural language summary that can incorporate user context data. This can result in a descriptive summary like “5 Cafes with quick service,” which can be more useful to the user in that specific context than a generic label.

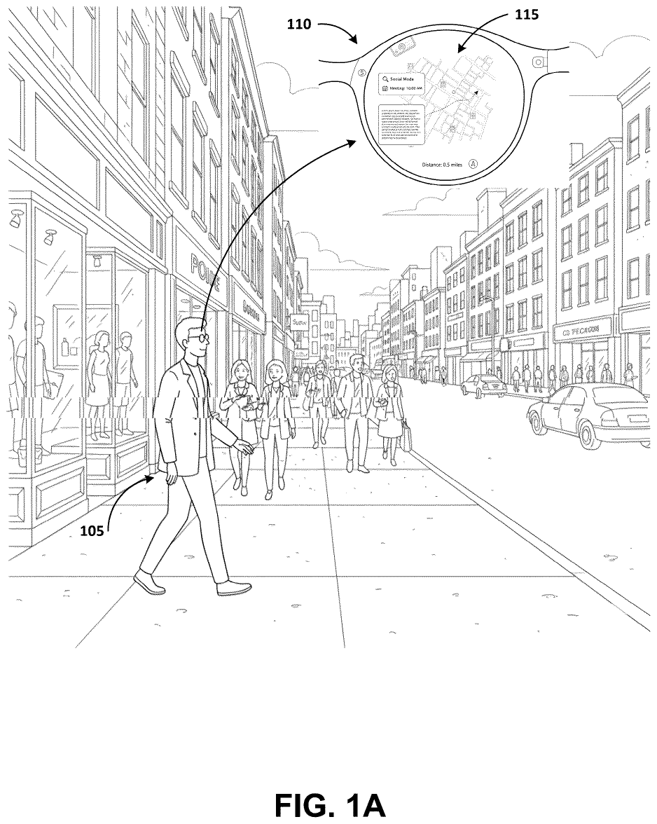

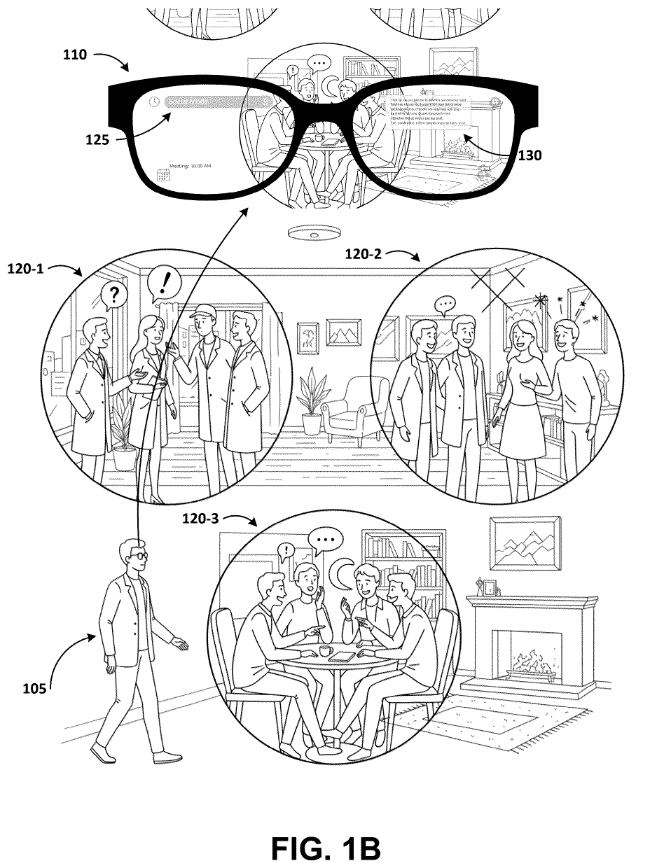

FIG. 1A illustrates a pictorial diagram of a physical environment according to an example implementation. In the example of FIG. 1A, a user 105 can be in a real-world environment including a busy sidewalk having many different types of shops and restaurants. The user 105 can be wearing a wearable device 110 (e.g., smart glasses). The user 105 can be using a map 115 displayed on the wearable device 110. Map 115 can correspond to the real-world environment. Map 115 can be displaying points of interest and/or information associated with the points of interest.

In some implementations, a process can be initiated in response to receiving a request for a representation associated with a location, for example, when user 105 wearing the wearable device 110 enters the area depicted. The wearable device 110 can be tasked with rendering a user interface, such as an augmented reality overlay, configured to present information about this location. FIG. 1A illustrates a dense urban street scene with a plurality of buildings, storefronts, and pedestrians. This environment can include a high density of informational objects (or entities), which can be considered points of interest, such as shops, restaurants, and services, each with associated data like names, types, and hours of operation.

In a conventional augmented reality or mapping application, attempting to display an icon or label for every point of interest in the scene shown in FIG. 1A would result in a cluttered and illegible user interface. Overlapping labels and icons would obscure the user's view and fail to provide a clear, actionable overview of the area's offerings. This problem is exacerbated on devices with limited display area, such as smart glasses, where screen space is at a premium.

By contrast, in some implementations semantic information associated with each point of interest in the location can be processed and the results rendered on the display. For example, the system can be configured to identify that the storefront is a clothing store, another establishment is a cafe, and a third is a bookstore. This semantic analysis moves beyond simply recognizing the presence of a building to understanding its function and attributes.

Based on this analysis, the system can be configured to generate summarized representations by clustering semantically similar objects. Instead of displaying individual icons for three different cafes on the block, the wearable device 110 can be configured to generate and display a user interface as a single, consolidated graphical element (e.g., map 115) with, for example, the text “3 Cafes.” This summarized representation provides a high-level overview while significantly reducing visual clutter.

The system can be configured to generate an interface for interacting with these summarized representations. For example, the “3 Cafes” label can be configured to function as an indicated graphical control element for that subset. User 105 can interact with this control element, such as by gazing at or selecting it, to trigger a semantic zoom. In response to this interaction, the user interface can be configured to display detailed information for the individual points of interest within that subset (e.g., the names and ratings of the three cafes) while other summarized groups remain collapsed. This provides an interactive way to manage information detail.

User interaction is not limited to graphical inputs like gazing or tapping. For example, the system can also be configured to accept voice commands to filter and manage the displayed information. This process begins by receiving a voice command including a natural language query from a user. For example, a user could issue the spoken query, ‘Show me Italian restaurants on this side of the street.’ The system then proceeds by identifying a filter criterion from the natural language query using a natural language understanding (NLU) engine. This engine can first perform speech-to-text conversion and then analyze the resulting text to perform intent recognition and entity extraction. In the given example, the NLU engine can identify the user's intent as filtering points of interest and extracts key entities: “Italian” is recognized and mapped to the ‘cuisine type’ feature, while “on this side of the street” is interpreted as a spatial constraint that is mapped to an accessibility feature. These extracted entities and their corresponding features can function as the filter criteria. Finally, the system can update the user interface to display the representation for the subset of the plurality of entities that matches the filter criterion. This update can involve re-calculating the subsets based on the new criteria and rendering only the relevant summaries or individual locations.

The level of detail of the representation can be dynamically adjusted and/or modified based on the physical distance from a user. This can be implemented using, for example, a set of configurable distance thresholds (e.g., <50 m, 50-200 m, >200 m) that map to different summarization strategies. For example, points of interest that are farther down the street (e.g., >200 m) or partially occluded can be grouped into more general summaries, such as “Shops and Services”. By contrast, those in the user's immediate vicinity (e.g., <50 m) can be represented with more specific summaries, such as “Italian Restaurant” and “Bookstore.” In some implementations, adjustments and/or modifications based on distance can be applicable to both visual points of interest and other entities like auditory sources.

Some implementations can include receiving a voice command including a natural language query from a user, for example, user 105 can speak a request to the wearable device 110. In some implementations, a filter criterion can be identified from the natural language query, which can be performed when the systems NLP engine parses the spoken words to extract constraints like “Italian” or “on this side”. In response to the query, some implementations can include updating the user interface, which can occur when the old summaries are replaced with the new, filtered results on the display.

In some implementations, a request can also be any trigger event, whether initiated by a user or by the system, that causes a process to begin for acquiring, processing, and rendering information associated with a location. In some implementations, a request can be a data structure or signal that serves as an input to a data processing pipeline, which contains parameters specifying a location of interest and the desired format for a resulting user interface. In some implementations, a request can be the initial command or event in a workflow that prompts a system to generate a summarized representation of entities by performing a sequence of operations including data acquisition, feature determination, clustering, and rendering.

In addition to adjusting and/or modifying detail based on distance, the system can also address challenges of visual occlusion. For example, in a dense urban environment viewed from a first-person perspective on smart glasses, many points of interest may be blocked by buildings. To determine which points are occluded, the system can leverage the real-time 3D map of the environment generated by its SLAM (Simultaneous Localization and Mapping) system. For each point of interest, the system can perform a visibility test by casting a virtual ray from the user's viewpoint (the camera's position) to the 3D coordinates of the point of interest. The system can check if this ray intersects with any geometry from the 3D map (e.g., a building polygon) before reaching its destination. If the ray is obstructed, the point of interest can be flagged as occluded. Otherwise, the point of interest can be considered visible. The system can then query a geospatial database for all points of interest located within the user's vicinity, perform this occlusion culling on them, and generate a summary for the occluded subset, such as a graphical element indicating “3 highly-rated restaurants around the corner.” This provides the user with awareness of their surroundings beyond their direct line of sight.

To achieve this result computationally, the system can perform several steps. First, the system can analyze the geometry of the 3D map to identify the primary occluding objects, such as the polygons representing the building directly in front of the user. Second, the system can construct a geometric representation of the occluded space behind this object. This can be achieved by creating a shadow volume, which is a 3D frustum projected from the user's viewpoint past the silhouette edges of the occluding object. This volume can mathematically define the region of space hidden from the user. Third, instead of querying for all nearby points of interest, the system can use the coordinates of this shadow volume as a spatial filter in its query to the geospatial database. The query can request only those points of interest that fall within the defined occluded volume. The returned subset of entities, already known to be occluded, can be passed to the summarization engine to generate the relevant summary.

In some implementations, a natural language query is not limited to a rigid command structure. For example, the query can refer to a command given in conversational, everyday speech, which the system can be configured to understand. The identified filter criterion can be any attribute or constraint derivable from the query, such as a category (e.g., cafes, parks), a temporal constraint (e.g., open now), a quality metric (e.g., highly rated), or a spatial constraint (e.g., nearby, on my left). Updating the user interface can refer to the dynamic re-rendering of the graphical elements on the display to reflect the newly filtered and summarized subset of entities.

This application of semantic summarization transforms the visually complex environment of FIG. 1A into a structured and easily navigable information space. By prioritizing and simplifying information based on its meaning, the system provides the user with a comprehensive yet uncluttered understanding of their surroundings, enabling more efficient decision-making and interaction with the physical world.

In some implementations, a method can include receiving a request for a representation associated with a location, which occurs when the wearable device 110 is to display information about the new environment. Second, the system identifies a plurality of points of interest associated with the location, corresponding to the various storefronts and services shown. Third, the system identifies a subset of the plurality of points of interest based on at least one criterion corresponding to at least one feature. For example, the system can identify a subset of cafes based on the criterion that the business type feature is cafe. Finally, the method can cause a user interface to be rendered on a display of wearable device 110, where this subset is shown as a single summarized representation (e.g., 3 Cafes).

Some implementations can identify user context data, such as when the system accesses the user's calendar. Some implementations can further include determining the feature of the entities based on the user context data, as when service speed is chosen as the relevant feature because of the upcoming meeting. Finally, some implementations can generate the representation as a natural language summary that incorporates the user context data. For example, the system can be configured to generate the descriptive text “5 Cafes with quick service.”

In some implementations a representation associated with a location may not limited to a single format. As an alternative to an augmented reality overlay on smart glasses, the representation could be a two-dimensional map displayed on a smartwatch. In this context, the plurality of points of interest would be icons on the map. Similarly, causing a user interface to be rendered can include various outputs tailored to a device (e.g., wearable device 110). For smart glasses, this could be a heads-up display element, while for a smartwatch, it could be an update to the map view that replaces cluttered icons with a summarized list or a single, interactive cluster icon.

In some implementations, user context data can include a wide range of inputs beyond the examples listed, including, for example, recent search queries, the currently active application on a companion device, or even biometric data from the wearable device that might indicate a user is in a hurry. Determining the feature based on this context can indicate that the system is not merely filtering on a pre-existing feature, but may be dynamically deriving a new, context-dependent characteristic (e.g., suitability for a business lunch) for the purpose of summarization. The natural language summary can be a generative output that is descriptive and conversational, distinguishing it from a simple quantitative label (e.g., “7 Restaurants”) by incorporating the reason for the summary (e.g., “7 restaurants suitable for large groups nearby”).

In some implementations, a user interface displays a map that includes an obstacle (e.g., a highway that can't be crossed). The system can identify a subset of the plurality of entities (the points of interest on the opposite, inaccessible side of the highway) as not relevant based on an accessibility criterion. The system then proceeds by occluding the subset of entities from the user interface, for example, by removing their corresponding icons from the map display. This ensures the user is only shown relevant and reachable points of interest. In another implementation corresponding to this obstructed scenario, instead of automatically removing the inaccessible points of interest, the system first queries the user for their preference. In response to determining that points of interest are on the far side of the highway, the user interface can be configured to render a non-intrusive prompt, such as a notification query the user, “Points on the other side of the highway may be difficult to reach. Hide them?” This act of “asking a user what to do” allows the user to decide whether to hide the information, keeping them in full control of the rendered interface.

A language processing model, model configured to process language, and/or natural language processing can be configured to use semantic labels associated with the location and points of interest at the location to generate new representations of information associated with the location. For example, the semantic labels associated with the location can include information indicating that the other side of the highway is not readily accessible. For example, the semantic labels can include information associated the points of interest. In one example, the points of interest can include several restaurants. Therefore, the semantic labels can include an indication that the business is a restaurant, the type of food served, hours of operation, price ranges, busy/slow times, ease of access (e.g., handicap seating), specialty services (e.g., allergy considerations), and the like.

illustrates another pictorial diagram of a physical environment according to an example implementation. In the example of FIG. 1B, semantic summarization can be applied to an auditory environment where the plurality of entities are distinct conversation groups existing simultaneously within the physical location. These entities are represented by the separate circular insets 120-1, 120-2, 120-3, where each group is engaged in a different type of interaction, as symbolized by the icons in the speech bubbles (e.g., questions, exclamations, ideas).

User 105 can experience cognitive overload from the cacophony of simultaneous speech streams. Wearable device 110, illustrated as smart glasses, can be equipped with microphones configured to capture this ambient audio. However, displaying a full transcription of every conversation would be impractical on a small display and would not solve the problem of information overload.

To manage this auditory information, some implementations can be configured to manage the plurality of conversations as the plurality of entities. The process for identifying these entities and their semantic features can begin by performing speech-to-text transcription of the audio captured from the physical environment. This step can convert the raw audio data into a structured textual format suitable for further analysis.

The process of identifying the plurality of entities can begin by capturing ambient audio from the physical environment using microphones associated with wearable device 110. The system then performs source localization to distinguish between the plurality of speakers present. Following this, speaker clustering algorithms can be applied to group the distinguished speakers into distinct conversation groups, where each group corresponds to one of the plurality of entities. The three groups 120-1, 120-2, 120-3 of FIG. 1B are an example of such identified entities.

Source localization can be achieved using microphone array processing techniques to determine the direction-of-arrival for different speech signals. Speaker clustering can then use voice-print analysis or other biometric voice characteristics to group audio streams originating from the same individuals and associate those individuals with a particular conversation based on conversational turn-taking and proximity. This robust process allows the system to accurately parse a complex auditory scene into discrete, analyzable conversation entities.

For example, source localization can employ algorithms like MUSIC (Multiple Signal Classification) or methods based on Time Difference of Arrival (TDOA) to estimate the bearing of each speaker. Speaker clustering can be implemented as a speaker diarization pipeline. This pipeline can generate speaker embeddings, such as i-vectors or deep learning-based x-vectors, which are numerical representations of a speaker's voice characteristics. Once these embeddings are generated for segments of speech, an algorithm like agglomerative hierarchical clustering can be used to group segments from the same speaker, and these speaker groups are then associated into conversations based on their spatial and temporal proximity.

Following transcription, a language processing model and/or a natural language processing (NLP) engine can be applied to the transcribed text from each conversation. The purpose of this step is to determine the feature of the conversation (e.g., a topic of the conversation). The NLP analysis can be configured to determine the topic of the conversation in group 120-1 as, for example, a “Brainstorming Session.” Similarly, the topic for the group 120-2 can be determined to be, for example, a “Project Update,” and the topic for the group 120-3 can be determined to be, for example, a “Social Chat.” These identified topics can be the features used to generate the summarized representations.

Some implementations can leverage a large language model (LLM) for this language processing model and/or natural language processing task. An LLM can understand nuance, context, and the overall substance of a discussion, allowing it to determine a more accurate and descriptive topic from the transcribed text. This enables the generation of highly relevant summary representations for the user.

These semantic summaries can be presented to the user through a user interface displayed on a wearable device 110, such as smart glasses. The representation for each conversation subset can be a graphical element 125, 130, such as a floating text label, overlaid on the user's view of the physical environment. Furthermore, in some implementations each representation can be positioned on the display to spatially correspond to the location of the subset. This spatial correspondence can be achieved using tracking technologies like Simultaneous Localization and Mapping (SLAM), where the device's cameras and sensors build a real-time 3D map of the surroundings and track the user's position within it. This allows the system to accurately anchor a digital representation, like the “Topic: Brainstorming” label, in the user's view so that it appears fixed to the physical location of the group of people having that conversation.

Some implementations include adjusting and/or modifying a level of detail of the representation based on a physical distance from a user. For example, a conversation entity that is closer to the user can be represented with a more verbose summary (e.g., “Discussion about AI ethics”), while a conversation farther away might be given a terse, high-level summary (e.g., “Sports”). The system is also configured to receive a user input selecting one of these representations. For example, a user might gaze at the “Discussion about AI ethics” label to select it. On a display with very limited space, the user could also interact with the interface to cycle through the available conversation summaries, for example by swiping or through a voice command. In response to a selection input, the system causes a display of a more detailed representation of the entities in that subset, such as a real-time scrolling transcript of that specific conversation.

Meanwhile, the other conversations can be configured to remain as high-level summaries, or their audio could be filtered out, preventing them from distracting the user. This technique of semantic summarization and interactive zooming transforms a complex auditory environment into a structured, navigable information space, allowing the user to efficiently understand and engage with their surroundings without being overwhelmed.

The auditory use case provides a specific implementation of the limitations recited in Claim 7. The plurality of entities are the plurality of conversations occurring in the room. The step of identifying these entities includes performing speech-to-text transcription of the audio captured from the environment. Finally, the feature upon which the representation is based is the topic of conversation, which is determined by applying a language processing model and/or natural language processing to the transcribed text.

The auditory use case also provides a specific implementation including adjusting and/or modifying a level of detail of the representation based on a physical distance from a user, as described by providing more verbose summaries for closer conversations and terse summaries for those farther away. Some implementations include receiving a user input selecting the representation, such as a user gazing at a summary label. Finally, in response to that user input, the system causes a display of a more detailed representation, for example by showing a full transcript of the selected conversation.

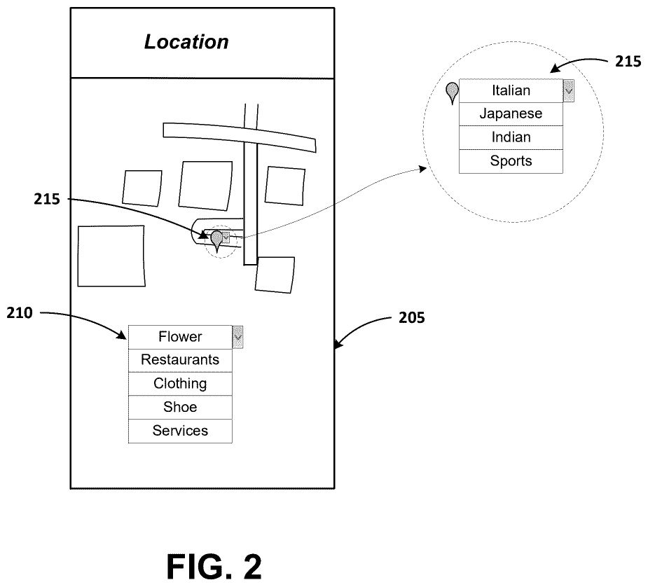

FIG. 2 illustrates a mapping user interface according to an example implementation. The mapping user interface 205 indicates several graphical control elements for subsets of points of interest. For example, a thumbtack icon (point of interest 215) can be indicated as a graphical control element representing a subset of restaurants. Additionally, a dropdown list (control element 210) serves as another graphical control element. The user interface provides an interface for interacting with these elements. For example, a user can select the thumbtack 215 to view the individual restaurants in that subset, or use the dropdown list 210 to filter or select different subsets of points of interest. This interaction allows the user to manage the information presented on the map.

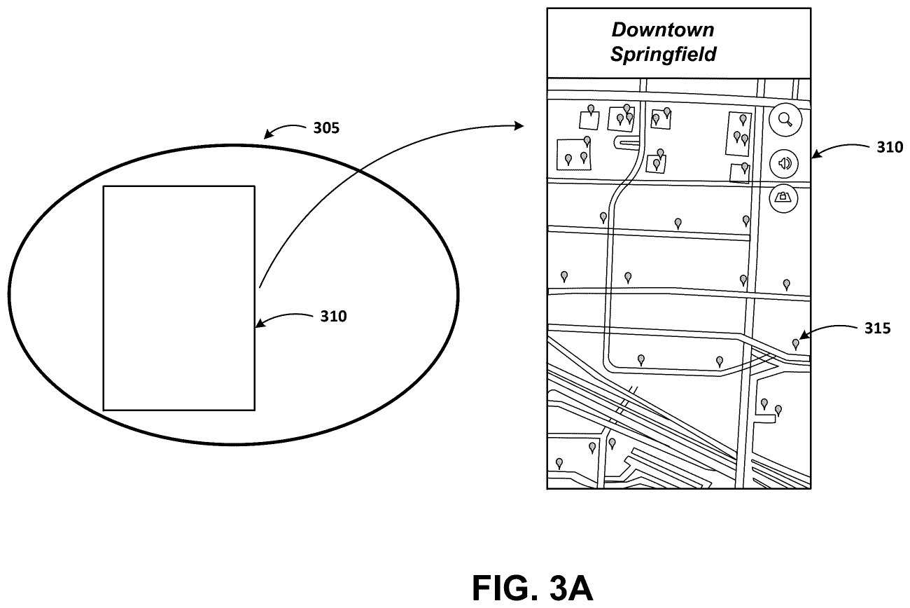

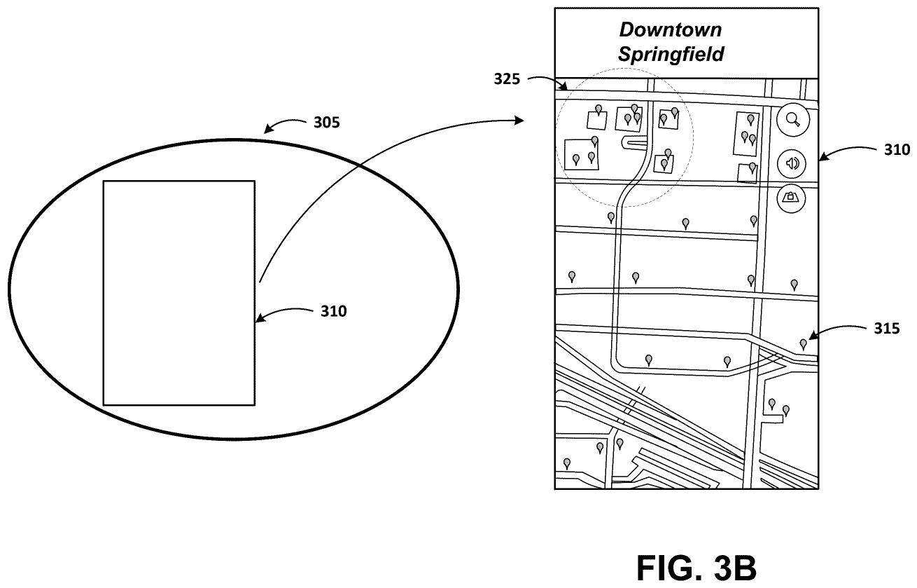

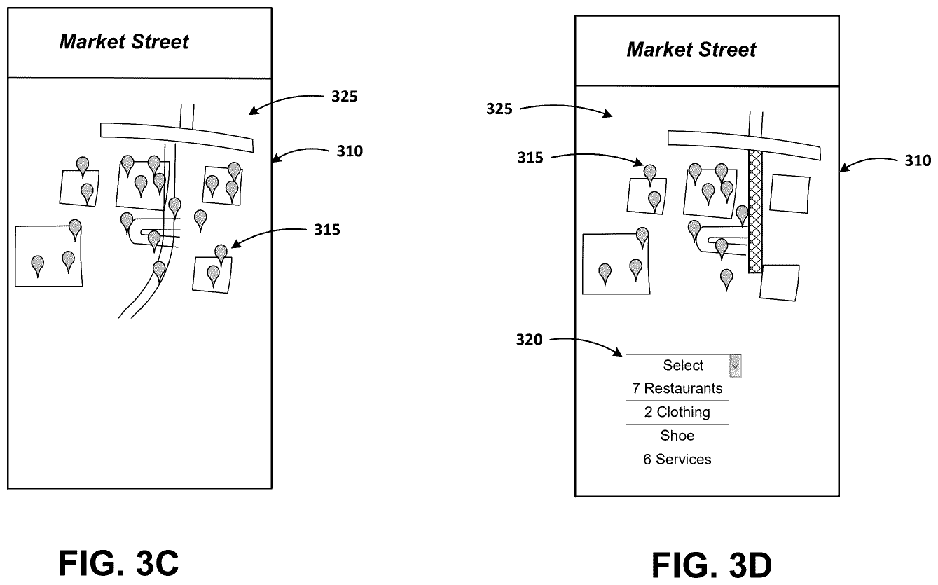

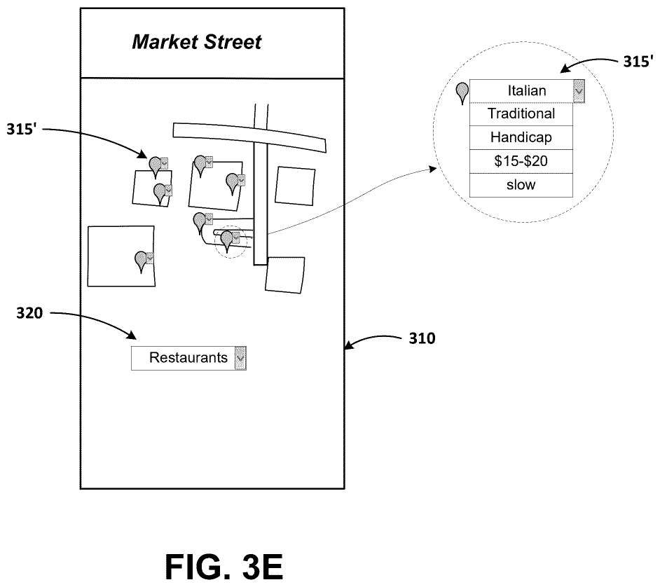

FIGS. 3A-3E show several stages of a mapping user interface according to at least one example implementation. As shown in FIGS. 3A-3E a device 305 can include a mapping user interface 310 operating on device 305. In some implementations, device 305 can be a handheld device (as shown). In some implementations, device 305 can be a wearable device (e.g., a head worn device). In some implementations, mapping user interface 310 can include a two-dimensional (2D) map or representation associated with a location. Therefore, in some implementations, device 305 can be configured to display 2D maps. In some implementations, mapping user interface 310 can include a three-dimensional (3D) map or representation associated with a location. Therefore, in some implementations, device 305 can be configured to display 3D maps or representations associated with a location.

To manage the display of numerous points of interest 315, the system indicates a graphical control element configured to represent a subset in a summarized manner, as shown with control element 320 in FIG. 3D. This technique is applicable to both a third-person perspective (e.g., viewing a map on a phone, tablet, or web browser) and a first-person perspective (e.g., an AR/VR view on a head-worn device). The control element 320, illustrated as a dropdown list, is one example of an indicated graphical control element. Other types of graphical control elements can also be indicated, such as a thumbtack icon, where a single thumbtack could be indicated on the map to represent a subset of all restaurants. These graphical control elements can be indicated as 2D elements on a map or as 3D elements in an augmented reality view.

In the map-based implementation, the representation for a subset is a graphical element indicating a quantity of the points of interest in that subset. For example, the control element 320 shown in FIG. 3D includes the representations “seven restaurants” and “two clothing stores.” These text-based graphical elements clearly indicate the quantity of points of interest that have been grouped into each respective subset.

FIG. 3D illustrates an example of removing points of interest that lack relevance. In this view, the system has identified the points of interest 315 to the right of the hashed road as lacking relevance, for example, because that area is not physically accessible to the user from their current location. In accordance with the claimed method, these identified points of interest are removed from the plurality of points of interest shown on the mapping user interface 310. This filtering step ensures that the subsequent summarization, shown via control element 320, is performed only on relevant and accessible points of interest, thereby providing a more useful and less cluttered user experience.

FIG. 3D illustrates an example where a subset of entities is occluded from the user interface. In this view, the system has identified the points of interest 315 to the right of the hashed road as a subset that is not relevant. This identification is based on an accessibility criterion, as that area is not physically reachable by the user. The method can include occluding this subset of entities from the mapping user interface 310 by removing them from the view. This ensures that subsequent summarization, shown via control element 320, is performed only on relevant and accessible points of interest.

The criteria for identifying a point of interest as lacking relevance are not limited to physical accessibility. Other factors can be used, such as temporal relevance. For example, a restaurant that is closed at the time the user is viewing the map can be identified as lacking relevance and subsequently removed from the display. Similarly, relevance can be determined based on user preferences or context; for example, if a user has indicated a preference for vegetarian food, meat-focused restaurants could be identified as lacking relevance and removed, personalizing the interface to the user's specific needs.

The criteria for identifying a point of interest as lacking relevance are not limited to physical accessibility. Other factors can be used, such as temporal relevance. For example, a restaurant that is closed at the time the user is viewing the map can be identified as lacking relevance and subsequently removed from the display. Similarly, relevance can be determined based on user preferences or context; for example, if a user has indicated a preference for vegetarian food, meat-focused restaurants could be identified as lacking relevance and removed, personalizing the interface to the user's specific needs.

To implement this, the system can determine relevance by querying underlying data sources and performing computations. To determine physical accessibility, the system can access a navigation graph associated with the map and run a pathfinding algorithm (e.g., A*) from the user's current location to the point of interest. If no viable path is found below a certain threshold (e.g., a path that does not require crossing a highway on foot), the point is identified as inaccessible. To determine temporal relevance, the system retrieves the point of interest's operating hours from a database and compares them against the current time provided by the device's system clock. If the current time falls outside the operating hours, the point is identified as not relevant.

In some implementations, the user of the mapping user interface 310 can zoom in or zoom out on the map. Zooming out on the map can cause the displaying of points of interest 315 in the same manner as in FIG. 3A (likely more points of interest 315). Therefore, processing of the information associated with the points of interest 315 can be similar to the discussion above. However, zooming in on the map can include selecting and/or zooming in on a region 325 of the map. FIG. 3C illustrates the region 325 of the map as displayed on the mapping user interface 310. In some use cases, additional points of interest 315 can be added to the region 325 of the map in a zoomed in representation as compared to the original representation of the region 325 of the map illustrated in FIG. 3B (or FIG. 3A).

Referring to FIG. 3D, in some implementations, points of interest 315 that are not useful to the user of the mapping user interface 310 can be hidden or removed from the mapping user interface 310. For example, the points of interest 315 to the right of the hashed road are removed. For example, the area to the right of the hashed road may not be accessible to the user. Therefore, including the points of interest 315 to the right of the hashed road may not be useful to the user.

Some implementations can include a control element 320 or graphical control element configured to display points of interest 315 in a summarized manner. Control element 320 is illustrated as a dropdown list. However, other graphical tools can be used. For example, a thumbtack can be used to represent a group of points of interest 315. For example, one thumbtack can represent all of the restaurants or types of restaurants (e.g., Italian, Mexican, and the like). Some implementations can be configured to represent a group of points of interest 315 from a third-person perspective (e.g., phone, tablet, web, and the like) or from a first-person perspective (AR/VR headset, and the like). In other words, some implementations can be configured to represent a group of points of interest 315 using a 2D control element and/or a 3D control element.

The control element 320 is an example of an indicated graphical control element for the identified subsets. In the example shown, it is a dropdown list that summarizes the points of interest 315 into categorized subsets: seven restaurants, two clothing stores, one shoe store, and six services. The graphical user interface provides an interface for interacting with these subsets via the control element 320. A user can select any of these entries to expand the subset and view more detailed information about the individual points of interest within it, such as viewing the locations of the seven restaurants.

Referring to FIG. 3E, in some implementations, as also shown in FIG. 3D, points of interest 315 that are not useful to the user of the mapping user interface 310 can be hidden or removed from the mapping user interface 310. For example, the points of interest 315 to the right of the hashed road are removed. For example, the area to the right of the hashed road may not be accessible to the user. Therefore, including the points of interest 315 to the right of the hashed road may not be useful to the user.

Some implementations can include a control element or graphical control element configured to display point of interest 315′ in a summarized manner. Point of interest 315′ includes a control element illustrated as a dropdown list. However, other graphical tools can be used. For example, a thumbtack can be used to represent a group of points of interest 315'. For example, one thumbtack can represent all of the restaurants or types of restaurants (e.g., Italian, Mexican, and the like). In FIG. 3E, point of interest 315′ is shown as being associated with an Italian restaurant having some specific characteristics. Some implementations can be configured to represent a group of points of interest 315′ from a third-person perspective (e.g., phone, tablet, web, and the like) or from a first-person perspective (AR/VR headset, and the like). In other words, some implementations can be configured to represent a group of points of interest 315′ using a 2D control element and/or a 3D control element.

In some implementations, data supporting a map or portion of a map for a location (representation associated with a location) can have an associated data structure representing points of interest (e.g., points of interest 315). The data structure can be, for example, a database. The data structure can include semantic data or semantic labels for a point of interest. Semantic data can be an effective tool to surface information in maps. For example, as the user of a mapping user interface zooms in and out, the different points of interest that are visible (e.g., restaurants, gas stations, cafes, parks, transportation, companies, entertainment, and the like) could be collapsed, expanded, and clustered based on their similarities and/or differences across some properties associated with (or included in) the semantic data. For example, if there are clusters of specific cuisine, then a set of restaurants could be clustered together as “5 japanese restaurants” and “3 indian restaurants”, or “7 live music venues” and “3 tennis courts”.

In addition to summarizing the types of restaurants, other properties could also be helpful, such as restaurant reviews (e.g., average 4.1 stars in this area) that are in the user of the mapping user interfaces'direction on a narrow street, addressing occlusion issues. This technique can improve how the system surfaces the underlying properties of a physical space to the user of the mapping user interface. This technique can enable the user of the mapping user interface to query the physical space with a more natural visual response. The mapping user interface can be further configured to summarize and/or expand clusters of information, such as types of images, or for summarizing long paragraphs that may not be legible at a particular zoom level. For example, a sign with text on it could have the text removed at a zoom level that is far enough away that the text may not be legible.

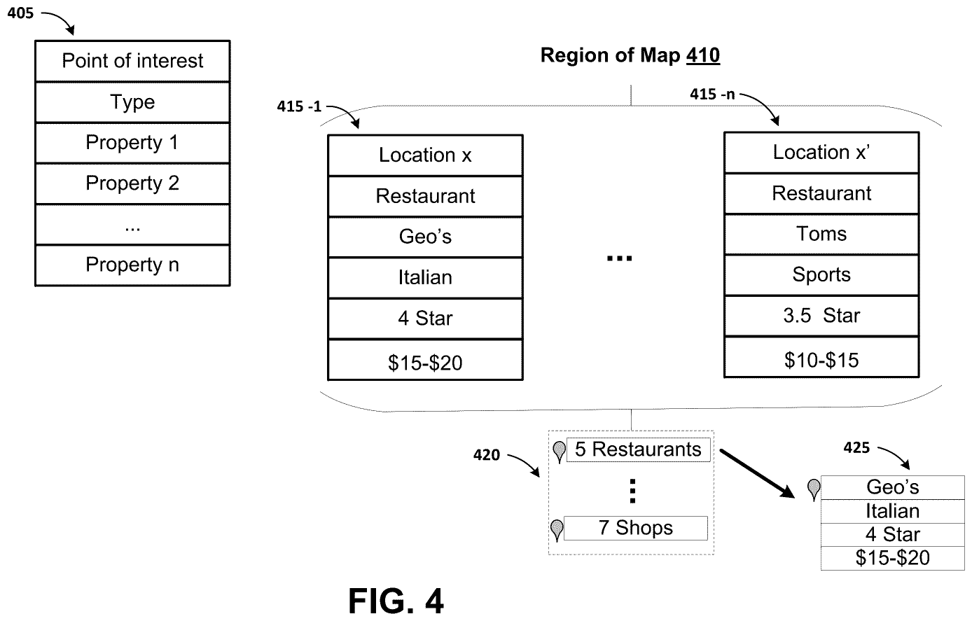

FIG. 4 is a block diagram of a data structure and a data flow according to at least one example implementation. As shown in FIG. 4 a data structure 405 can represent a point of interest. The data structure can include, for example, data representing a type of point of interest and at least one property or feature associated with the point of interest. The property or feature can include, for example, semantic data or semantic labels. As an example, a region of a map 410 (or representation associated with a location) can include a plurality of points of interest. In some implementations, a point of interest can be identified by its location (e.g., geolocation, address, cartesian coordinates, and the like.

For example, a first point of interest 415-1 can be identified by a location x and an nth point of interest 415-n can be identified by a location x′. Point of interest 415-1 and point of interest 415-n can be restaurants as a property or feature. Point of interest 415-1 can also have properties including Geo's (e.g., a name of the restaurant), Italian (e.g., type of food), 4 star (e.g., a rating), and $15-$20 (e.g., a price range). Point of interest 415-n can also have properties including Toms (e.g., a name of the restaurant), Sports (e.g., type of restaurant), 3.5 star (e.g., a rating), and $10-$15 (e.g., a price range).

In response to a user of a mapping user interface (e.g., mapping user interface 205, 310) requesting a map (or representation associated with a location) associated with a location and/or region, a plurality of points of interest can be identified for the location and/or region. However, instead of displaying an indication for all of the points of interest on the map(or representation associated with a location), some implementations can process semantic information associated with the points of interest. For example, the properties for each point of interest (415-1 . . . 415-n) can be read from a data structure. Processing can continue by, for example, grouping points of interest based on at least one of the properties. For example, as shown in FIG. 4, the points of interest can be grouped 420 (or clustered) by the type of point of interest. Then the grouping 420 (or cluster) can be displayed on the mapping user interface (e.g., using elements 210, 215, 315′, 320, and/or the like). In some implementations, a number of points of interest associated with the group (e.g., five (5) restaurants, seven (7) shops, and the like) can be included (and displayed) with the group 420. By using the grouping 420 (or cluster), the number of indicators on the map (or representation associated with a location) can be minimized and be more useful to the user of the mapping user interface.

In some implementations, the user of the mapping user interface can select one of the groups 420. For example, the user of the mapping user interface can select the restaurant group. As shown in FIG. 4, selecting one of the groups 420 can cause displaying of the points of interest associated with the group. For example, selecting the restaurant group can cause point of interest 425 to be displayed with point of interest 425 properties. FIG. 2-FIG. 4 specifically detail the map use case of FIG. 1A. However, similar functionality can be implemented in the conversation use case of FIG. 1B as well as other use cases exemplified below.

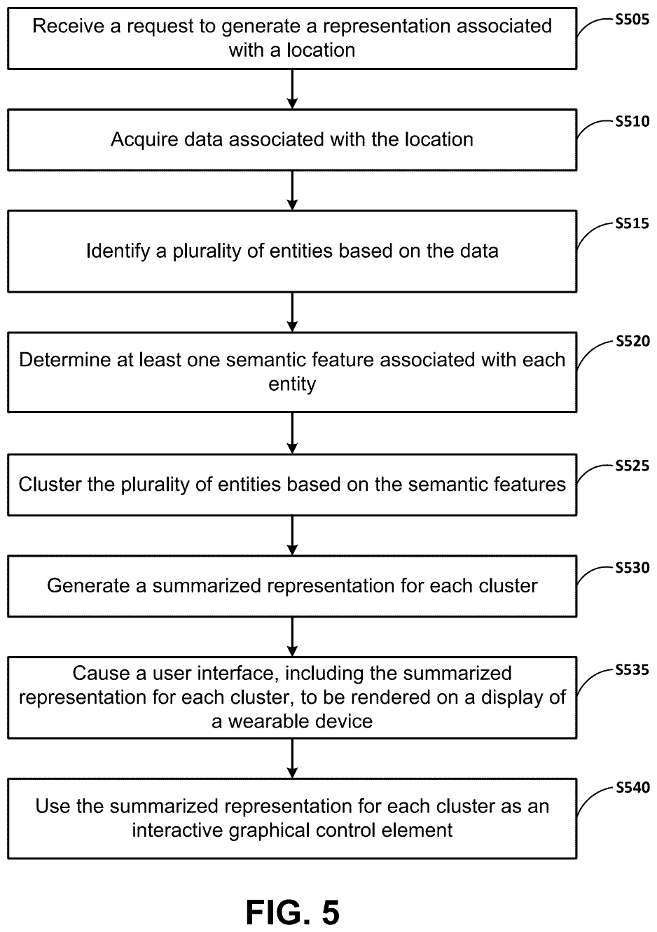

FIG. 5 is a block diagram of a method of displaying data associated with a location (or representation associated with a location) according to an example implementation. As shown in FIG. 5, in step S505, receive a request to generate a representation associated with a location. This request can be either explicit or implicit. For example, an explicit request is a direct user action, such as opening a map application on a smartwatch, tapping a “show nearby places” button in a user interface, or issuing a voice command like, “What's around me?” An implicit request, however, is initiated by the system based on contextual cues without direct user input. For example, the system can trigger a request automatically when the user's wearable device detects entry into a new geofenced area, such as a shopping district, or when a user's movement patterns indicate they are looking for information, such as pausing on a street corner and looking around.

The term “location” in this step is interpreted broadly to cover both physical and digital environments. In a physical context, the location is a geospatial area defined by data from the device's positioning systems, such as GPS, Wi-Fi triangulation, or cellular network data. The request is therefore associated with a specific set of geographic coordinates. In a digital context, the “location” refers to the user's current viewport or focus within a digital information space. For example, it could be the visible portion of an infinite canvas on a collaborative whiteboard or a specific directory in a file system. The request, in this case, is to generate a representation of the digital assets contained within that defined digital boundary.

The request itself is more than a simple trigger; it is a data packet that provides essential context for the subsequent steps of the method. This packet includes an identifier for the location (e.g., GPS coordinates or viewport coordinates), metadata about the requesting device (e.g., “smartwatch” or “head-worn device”), and the type of representation required (e.g., “2D map” or “AR overlay”). This information is critical as it defines the constraints for rendering, such as the available display area and the appropriate interaction modalities. The request may also contain initial user-defined parameters, such as an active search query (e.g., “restaurants”) or pre-set filters, which are used to guide the filtering and clustering processes.

For example, consider a user wearing smart glasses walking through the urban environment depicted in FIG. 1A. As the user turns onto a new street, the device's inertial measurement unit and GPS detect a significant change in location and orientation. This change triggers an implicit request (step S505) to generate an updated augmented reality representation for the user's new field of view. The request contains the user's new GPS coordinates, the direction they are facing from the compass, and a flag indicating the request is for an AR overlay. The system then uses this information to proceed to step S510, acquiring the relevant data to fulfill the request by summarizing the points of interest on the new street.

In step S510, acquire data associated with the location. For example, acquiring data can include retrieving the raw information necessary to identify the entities within the bounds defined by the request from step S505. The nature of this data acquisition depends on the context. For a physical location, this typically includes sending a query, containing the location identifier (e.g., GPS coordinates and a radius or a defined viewport), to one or more remote data sources. These sources can include geospatial databases for points of interest, real-time transit APIs for transportation information, or other third-party services. For a digital information space, this step includes accessing and reading the data structure of the space itself, such as iterating through the objects on a digital canvas or listing the files in a directory.

Continuing the example, after the system generates the implicit request upon the user turning the corner, it proceeds to step S510. Based on the request packet, the system constructs a query for a remote geospatial database. The query specifies a bounding box defined by the user's current GPS coordinates and their field of view. The database returns a data payload containing all points of interest within that specified area. This payload is a collection of structured data objects, where each object represents a business or landmark and contains its name, precise geolocation, business category, user ratings, and operating hours. At this stage, the data is comprehensive but unfiltered, including every cafe, shop, and service in the user's view.

When the user subsequently makes the explicit voice request for “clothing stores,” the data acquisition in step S510 is more efficient. The new request packet from step S505 includes the filter criterion. The system now constructs a more targeted database query. Instead of requesting all points of interest, the query is formulated to query for only those entities where the business type feature is equal to clothing store within the specified geospatial bounds. This pre-filtered query significantly reduces the amount of data that needs to be transferred and processed, as the remote server performs the initial filtering, returning only the data for the relevant clothing stores.

The output of step S510, for both the implicit and explicit requests, is a structured data set. This data, often formatted as JSON or a similar machine-readable format, serves as the direct input for step S515 (identify a plurality of entities). For example, after the explicit request, the acquired data would be a list of data objects, each corresponding to a specific clothing store from FIG. 1A. Each object would contain key-value pairs for properties like name: “POIDE”, category: “clothing”, location: {lat: . . . , lon: . . . }, and rating: “4.2”. This structured data provides the necessary foundation for the system to formally identify each store as a distinct entity and begin extracting the semantic features needed for summarization in the subsequent steps.

In step S515, identify a plurality of entities based on the data. For example, this step can be the computational step of parsing the raw data acquired in S510 and instantiating it into a structured collection of discrete, addressable objects that the system can process. This includes iterating through the acquired data (e.g., a JSON array from a database) and, for each entry, creating a corresponding in-memory entity object. Each of these objects represents a single, distinct point of interest, conversation group, or digital asset. The result of this step is a formal, machine-readable list—the “plurality of entities” that serves as the foundational dataset for all subsequent filtering, clustering, and summarization operations.

Continuing the example after the user's implicit request (turning the corner), the system in step S515 processes the large data payload containing all points of interest in the new field of view. It iterates through each JSON object in the payload. For the storefront labeled “POIDE,” it creates an entity object and populates it with the acquired data. It does the same for the cafe, the bookstore, and every other point of interest returned by the database. The output is a comprehensive list of all entities currently visible to the user, each now represented as a distinct object in the system's memory, ready for feature extraction.

Following the user's subsequent explicit voice request for “clothing stores,” the process in step S515 is similar but operates on a smaller dataset. The system parses the pre-filtered data payload acquired in S510, which contains only clothing stores. It iterates through this smaller list and creates an entity object for each one. For example, it would instantiate an entity object for “POIDE” and any other identified clothing stores. The resulting “plurality of entities” in this case is a much smaller, more targeted collection that contains only the entities matching the user's immediate query.

The final output of step S515 is this crucial, well-defined list of entity objects. Whether the list is large (from an implicit request) or small (from an explicit request), it is now in a state where the system can act upon it. This list is passed as the direct input to step S520 (determine at least one semantic feature). The system will then proceed to iterate through this specific list of entity objects, one by one, to extract the semantic features needed for the clustering and summarization that follows. This step effectively transforms a raw data stream into a workable set of computational objects.

In step S520, determine at least one semantic feature associated with each entity. For example, determining a semantic feature can include iterating through the list of entity objects identified in step S515 and extracting or deriving the specific attributes that will be used for clustering. This is a crucial data enrichment phase. For entities where features are available as simple metadata (e.g., a business type field in a database), this step may include merely reading and normalizing these values. For more complex entities or features, this step can include significant computation, such as running an NLP model on unstructured text (like user reviews) to determine sentiment or key themes or applying a machine learning model to an image to classify its content.

Continuing the example after the user's implicit request, the system in step S520 processes the comprehensive list of all entities in the user's field of view. For each entity object, it accesses the associated data and extracts relevant features. For the entity representing a cafe, it extracts features like category: “cafe”, rating: 4.5, and price_range: “$$”. For the entity representing the “POIDE” storefront, it extracts category: “clothing”. In some cases, it may perform additional analysis; for example, it could process the text of recent user reviews for the cafe to derive a new feature, such as ambiance: “cozy”.

Following the user's explicit voice request for “clothing stores,” the process in step S520 is performed on the smaller, pre-filtered list of entities. The system iterates through this list, which now only contains clothing stores, and extracts their semantic features. For the “POIDE” entity, it again extracts category: “clothing”. It might also extract more specific features available in its data, such as style: “boutique” or price_point: “high-end”. This step ensures that every entity in the current working set has a structured list of semantic features that can be compared against other entities.

The output of step S520 is the same list of entity objects from S515, but now each object is annotated with a structured set of key-value pairs representing its semantic features. For example, the “POIDE” entity object now explicitly contains features: {category: “clothing”, style: “boutique”}. This enriched, feature-tagged list of entities is the direct input for step S525 (cluster the plurality of entities). The clustering algorithm will use these specific features to computationally determine which entities are similar enough to be grouped together into a subset.

In step S525, cluster the plurality of entities based on the semantic features. For example, clustering entities can be where the system identifies logical groupings within the feature-annotated list of entities from step S520. This is the core summarization step that creates the subsets. To perform this, the system applies a clustering algorithm (e.g., k-means or DBSCAN) based on a defined criterion. The semantic features of each entity are first converted into a numerical format, such as a feature vector, allowing the algorithm to mathematically calculate the similarity or “distance” between entities. The algorithm then groups entities that are close to each other in the multi-dimensional feature space, forming one or more distinct clusters.

Continuing the example after the user's implicit request, the system has a large list of diverse entities. In step S525, it applies a clustering algorithm where the primary criterion is the category feature. The algorithm processes the feature vectors of all entities and identifies distinct groups. For example, it will group all entities whose category feature is “cafe” into one cluster. Similarly, it will form a separate cluster for all entities with the category feature “clothing,” and so on for bookstores, services, etc. The result is a set of clusters, each representing a different type of business visible to the user.

Following the user's explicit voice request for “clothing stores,” the system in step S525 operates on the smaller, pre-filtered list of entities. While all entities are now of the same general category, clustering can still be applied to find finer-grained distinctions. For this list, the clustering criterion might be a combination of the style and price_point features. The algorithm could then identify and create two distinct subsets from the available clothing stores: a first cluster for entities with features like style: “boutique” and price_point: “high-end”, and a second cluster for those with features like style: “chain_store” and price_point: “mid-range”.

The output of step S525 is a structured set of one or more clusters, where each cluster is itself a list of entity objects that share a common semantic property based on the applied criterion. These identified clusters are the “subsets” that are ready for summarization. This structured grouping is passed as the direct input to step S530 (generate a summarized representation), where a single representative label or description will be created for each of these newly formed clusters.

In step S530, generate a summarized representation for each cluster. For example generating a summarized representation can include creating a single, concise graphical or textual element for each cluster identified in step S525. This step transforms a list of individual entities into a human-readable summary. The generation can be rule-based, resulting in a quantitative summary (e.g., counting the entities and using the shared feature as a label), or it can be generative, using a large language model (LLM) to synthesize a more descriptive, natural language summary based on the collective features of the entities within the cluster.

Continuing the example after the user's implicit request, the system in step S530 processes the clusters formed based on the category feature. For the cluster containing three cafe entities, the system applies a rule-based approach: it counts the entities (three) and appends the shared category (“cafe”). It generates the simple, quantitative representation: “3 Cafes.” It performs the same operation for the other clusters, generating representations like “5 Clothing Stores” and “2 Bookstores.” These summaries are efficient and provide a clear, at-a-glance overview of the user's surroundings.

Following the user's explicit voice request for “clothing stores,” the system has identified more nuanced sub-clusters based on style and price. For these, it employs a generative approach. For the first cluster containing high-end boutiques, the system constructs a prompt for an LLM that includes the names and key features (e.g., style: “boutique”, price_point: “high-end”) of the entities in that cluster. The LLM processes this information and generates a descriptive, natural language summary: “High-end boutiques.” A similar process for the second cluster might yield the summary “Mid-range chain stores.” This demonstrates a more sophisticated level of summarization that captures the qualitative essence of the group.

The output of step S530 is a data structure that maps each cluster (the subset of entities) to its newly generated summarized representation. For example, the output would contain a mapping like {cluster_id_1: “3 Cafes”, cluster_id_2: “High-end boutiques”}. This structure, which now contains the final content to be displayed, is passed as the direct input to step S535 (cause a user interface to be rendered), where these representations will be drawn onto the display of the user's wearable device.

In step S535, a user interface, including the summarized representation for each cluster, to be rendered on a display of a wearable device. For example, the summaries generated in step S530 are translated into a visual user interface on the wearable device. This includes the system's rendering engine taking the data structure that maps each cluster to its representation and drawing the corresponding graphical elements on the display. For an augmented reality device, this step is particularly complex, as it requires not only rendering the elements but also positioning them correctly within the user's view of the physical world, so they appear anchored to real-world locations.

Continuing the example after the user's implicit request, the system in step S535 renders the quantitative summaries (“3 Cafes,” “5 Clothing Stores”) as AR labels. Using data from its Simultaneous Localization and Mapping (SLAM) system, the device determines the 3D position of the physical storefronts. It then renders the “3 Cafes” label as a floating graphical element that spatially corresponds to the physical location of that group of cafes. Similarly, the “5 Clothing Stores” label is anchored in the user's view over the corresponding shops. The user sees a clean, summarized overlay of their environment rather than a clutter of individual icons.

Following the user's explicit voice request for “clothing stores,” the system first clears the previous AR elements from the display. It then proceeds to render the new, more descriptive summaries generated in step S530. The label “High-end boutiques” is rendered and spatially anchored over the specific group of stores that includes “POIDE,” while the “Mid-range chain stores” label is anchored over the other group. This dynamic updating of the user interface provides immediate visual feedback in response to the user's query, replacing the general overview with a more focused and detailed one.

The output of step S535 is the rendered user interface that the user directly sees and interacts with. The graphical elements, the summary labels themselves, are now active on the display. This rendered state is the direct prerequisite for the final step in the method, S540 (use the summarized representation as an interactive graphical control element). The system's input manager is now listening for user interactions, such as a gaze or tap, directed at these newly rendered labels to initiate a “semantic zoom.”

In step S540, use the summarized representation for each cluster as an interactive graphical control element. For example, the summary labels rendered in step S535 may not be static information. Instead, they can be active user interface elements. The system's input manager is configured to continuously monitor user interactions directed at these elements, such as gaze fixation, hand gestures (e.g., a tap or a pinch), or voice selection. When a user selects one of these summaries, it triggers a “semantic zoom,” which is a contextual drill-down operation that reveals the individual entities that were grouped within the selected subset.

Continuing the example after the user's initial implicit request, the user sees the AR labels “3 Cafes” and “5 Clothing Stores” floating in their view. Deciding they want a coffee, the user focuses their gaze on the “3 Cafes” label for a predefined duration (e.g., one second), which the system interprets as a selection command. In response, the system executes the semantic zoom: the “3 Cafes” label is removed from the display and is replaced by three new, more detailed labels, each showing the name and rating of an individual cafe. These new labels are rendered and spatially anchored near their respective physical storefronts, while the “5 Clothing Stores” summary remains collapsed, maintaining a decluttered view.

In the scenario following the user's explicit voice request, the user is presented with the more descriptive summaries, “High-end boutiques” and “Mid-range chain stores.” The user decides to explore the boutique options and performs a small tap gesture with their finger while looking at the “High-end boutiques” label. The system's camera and hand-tracking software register this gesture as a selection. In response, the “High-end boutiques” label is replaced by individual AR labels for each store in that subset, such as one for “POIDE” and another for a different boutique, displaying their names and perhaps a key feature like “Designer Apparel.”

The output of step S540 is an updated user interface state that provides a detailed view of a selected subset while keeping others summarized. This action completes the user's workflow, allowing them to seamlessly transition from a high-level, uncluttered overview to specific, actionable information about the entities that interest them most. After performing the semantic zoom, the system returns to an idle state, ready to process the next user interaction, which could be another selection, a new voice command that initiates a new request (looping back to S505), or the user disengaging.

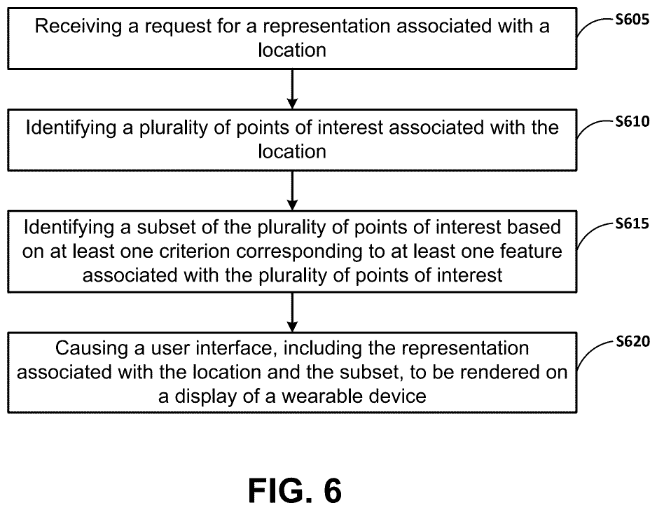

Example 1. FIG. 6 is a block diagram of a method of generating a map for a location (or representation associated with a location) according to an example implementation. As shown in FIG. 6, in step S605 receiving a request for a representation associated with a location. In step S610 identifying a plurality of points of interest associated with the location. In step S615 identifying a subset of the plurality of points of interest based on at least one criterion corresponding to at least one feature associated with the plurality of points of interest. In step S620 causing a user interface, including the representation associated with the location and the subset, to be rendered on a display of a wearable device.

Example 2. The method of Example 1 can further include identifying at least one of the plurality of points of interest as a point of interest lacking relevance based on a criterion. For example, the criterion can be temporal, where the system identifies a restaurant as lacking relevance by retrieving its operating hours from a database and comparing them to a current device time to determine it is closed. The method can further include removing the identified point of interest from the plurality of points of interest.

Example 3. The method of Example 1 can further include identifying at least one of the plurality of points of interest as a point of interest lacking relevance based on a criterion. For example, the criterion can be temporal, where the system identifies a restaurant as lacking relevance by retrieving its operating hours from a database and comparing them to a current device time to determine it is closed. The method can further include querying a user of the representation associated with the location what to do with the at least one of the plurality of points of interest as a point of interest lacking relevance.

Example 4. The method of Example 1 can further include indicating graphical control element for the subset on a graphical user interface and providing, on the graphical user interface, at least one interface for interacting with one of the plurality of points of interest or the subset of the plurality of points of interest.

Example 5. The method of Example 1 can further include indicating graphical control element for the subset.

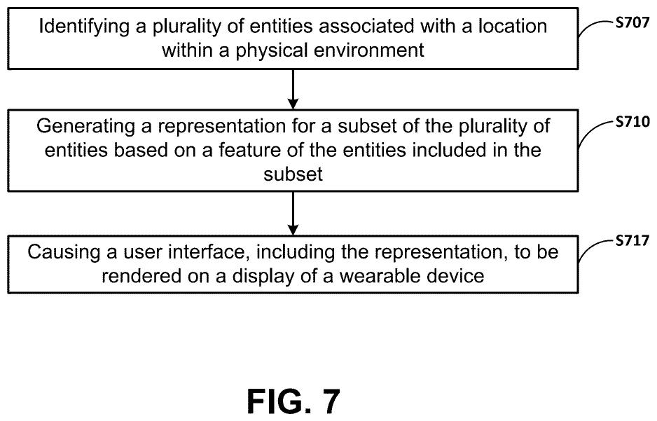

Example 6. FIG. 7 is a block diagram of a method of generating a representation for a location according to an example implementation. As shown in FIG. 7, in step S705 identifying a plurality of entities associated with a location within a physical environment. In step S710 generating a representation for a subset of the plurality of entities based on a feature of the entities included in the subset. In step S715 causing a user interface, including the representation, to be rendered on a display of a wearable device.

Example 7. The method of Example 6, wherein the plurality of entities can include a plurality of conversations. Identifying the plurality of entities can include performing speech-to-text transcription of audio captured from the physical environment to produce transcribed text. The feature can be a topic of conversation, which is determined by applying a computational linguistic analysis, such as a natural language processing model, to the transcribed text to identify semantic themes or subjects within the conversation.

Example 8. The method of Example 6 can further include adjusting and/or modifying a level of detail of the representation based on a physical distance from a user, receiving a user input selecting the representation, and in response to the user input, causing a display of a more detailed representation of the entities included in the subset.

Example 9. The method of Example 6, wherein the user interface can be displayed on a head-worn device, the representation can be a graphical element overlaid on a view of the physical environment, and the representation can be positioned on the display to spatially correspond to the location of the subset.

Example 10. The method of Example 6, wherein identifying the plurality of entities can include capturing ambient audio from the physical environment, performing source localization to distinguish between a plurality of speakers and clustering the plurality of speakers into distinct conversation groups, wherein the distinct conversation groups correspond to one of the plurality of entities.

Example 11. The method of Example 6, wherein the entities can be points of interest on a map, the representation can be a graphical element indicating a quantity of the points of interest in the subset, and the method can further include identifying a subset of the plurality of entities as not relevant based on an accessibility criterion and occluding the subset of entities from the user interface.

Example 12. The method of Example 6 can further include receiving a voice command including a natural language query from a user, identifying a filter criterion from the natural language query, and updating the user interface to display the representation for the subset of the plurality of entities that matches the filter criterion.

Example 13. The method of Example 6 can further include identifying user context data, wherein the user context data includes at least one of a calendar event, a time of day, or a user location history, determining the feature of the entities based on the user context data, and generating the representation as a natural language summary that incorporates the user context data.

Example 14. The method of Example 6, wherein the location can be a digital information space, the plurality of entities can be digital assets within the digital information space, and the feature can be a topic shared by a plurality of the digital assets.

Example 15. A method can include any combination of one or more of Example 1 to Example 14.

Example 16. A non-transitory computer-readable storage medium comprising instructions stored thereon that, when executed by at least one processor, are configured to cause a computing system to perform the method of any of Examples 1-15.

Example 17. An apparatus comprising means for performing the method of any of Examples 1-15.

Example 18. An apparatus comprising at least one processor and at least one memory including computer program code, the at least one memory and the computer program code configured to, with the at least one processor, cause the apparatus at least to perform the method of any of Examples 1-15.

A further use case is the application of semantic summarization to collaborative digital information spaces, such as an infinite canvas-style digital whiteboard. In such an environment, a plurality of entities can exist as digital assets, including sticky notes, images, text boxes, and design components. When a user zooms out, a dense cluster of these assets can become illegible. The system can identify a subset of assets based on a shared feature, such as a common topic derived from the text on sticky notes or a shared author. It then generates a single summarized representation, such as “15 Notes on Q4 Marketing,” to replace the cluttered view, allowing the user to understand the substance of a section of the board without needing to zoom in.

The method is also applicable to managing large media libraries, such as a music playlist, on a device with a limited display, like a smartwatch. In this scenario, the individual songs or media files are the plurality of entities. Instead of displaying a long, scrollable list of titles, the system can identify a subset of entities based on features derived from user context and metadata, such as listening history, genre, or artist. The system then generates a summarized representation that is contextually relevant, such as “Top 3 Recommended Tracks for Your Morning Run” or “5 Unplayed Podcasts,” simplifying navigation and content discovery for the user.

Semantic summarization can also enhance file system navigation. When a user browses a directory containing a large number of files, the files represent the plurality of entities. In a folder with hundreds of image files, a traditional file browser would present a long, undifferentiated list. The system can instead identify subsets based on features like file type, creation date, or even content analyzed through machine learning (e.g., identifying all images containing landscapes). The user interface can then be updated to show summarized representations like “250 JPEGs from November 2025” or “32 Photos from the Beach Trip,” providing a more intuitive and organized overview of the folder's contents.

In some implementations, wearable 110 can be configured to perform the processing described herein. However, a companion device (e.g., a computing device, a mobile phone, a tablet, a laptop computer, and/or the like) communicatively coupled to wearable device 110 can be configured to perform some or all of the implementations described herein. For example, the companion device can be configured to receive (e.g., via a wired and/or wireless connection) data from wearable device 110 which can be further processed by the companion device. The companion device can also be configured to receive audio data, location data, motion data, inertial data, and/or the like to perform the processing described herein. The companion device can be configured to process data as described above and communicate images and/or video from the companion device to wearable device 110 for display by wearable device 110.

Example implementations can include a non-transitory computer-readable storage medium comprising instructions stored thereon that, when executed by at least one processor, are configured to cause a computing system to perform any of the methods described above. Example implementations can include an apparatus including means for performing any of the methods described above. Example implementations can include an apparatus including at least one processor and at least one memory including computer program code, the at least one memory and the computer program code configured to, with the at least one processor, cause the apparatus at least to perform any of the methods described above.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (a LED (light-emitting diode), or OLED (organic LED), or LCD (liquid crystal display) monitor/screen) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

While example implementations may include various modifications and alternative forms, implementations thereof are shown by way of example in the drawings and will herein be described in detail. It should be understood, however, that there is no intent to limit example implementations to the particular forms disclosed, but on the contrary, example implementations are to cover all modifications, equivalents, and alternatives falling within the scope of the claims. Like numbers refer to like elements throughout the description of the figures.

Some of the above example implementations are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed above, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

Specific structural and functional details disclosed herein are merely representative for purposes of describing example implementations. Example implementations, however, be embodied in many alternate forms and should not be construed as limited to only the implementations set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example implementations. As used herein, the term and/or includes any and all combinations of one or more of the associated listed points of interest.

It will be understood that when an element is referred to as being connected or coupled to another element, it can be directly connected or coupled to the other element or intervening elements may be present. In contrast, when an element is referred to as being directly connected or directly coupled to another element, there are no intervening elements present. Other words used to describe the relationship between elements should be interpreted in a like fashion (e.g., between versus directly between, adjacent versus directly adjacent, etc.).

The terminology used herein is for the purpose of describing particular implementations only and is not intended to be limiting of example implementations. As used herein, the singular forms a, an and the are intended to include the plural forms as well, unless the context clearly indicates otherwise. It will be further understood that the terms comprises, comprising, includes and/or including, when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts included.

Unless otherwise defined, all terms (including technical and scientific terms) used herein have the same meaning as commonly understood by one of ordinary skill in the art to which example implementations belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the above example implementations and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the above illustrative implementations, reference to acts and symbolic representations of operations (e.g., in the form of flowcharts) that may be implemented as program modules or functional processes include routines, programs, objects, components, data structures, etc., that perform particular tasks or implement particular abstract data types and may be described and/or implemented using existing hardware at existing structural elements. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as processing or computing or calculating or determining of displaying or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example implementations are typically encoded on some form of non-transitory program storage medium or implemented over some type of transmission medium. The program storage medium may be magnetic (e.g., a floppy disk or a hard drive) or optical (e.g., a compact disk read only memory, or CD ROM), and may be read only or random access. Similarly, the transmission medium may be twisted wire pairs, coaxial cable, optical fiber, or some other suitable transmission medium known to the art. The example implementations are not limited by these aspects of any given implementation.

Lastly, it should also be noted that whilst the accompanying claims set out particular combinations of features described herein, the scope of the present disclosure is not limited to the particular combinations hereafter claimed, but instead extends to encompass any combination of features or implementations herein disclosed irrespective of whether or not that particular combination has been specifically enumerated in the accompanying claims at this time.

What is claimed is:

1. A method comprising:
receiving a request for a representation associated with a location;
identifying a plurality of points of interest associated with the location;
identifying a subset of the plurality of points of interest based on at least one criterion corresponding to at least one feature associated with the plurality of points of interest; and
causing a user interface, including the representation associated with the location and the subset, to be rendered on a display of a wearable device.

2. The method of claim 1, further comprising:
identifying at least one of the plurality of points of interest as a point of interest lacking relevance based on a criterion; and
removing the point of interest lacking relevance from the plurality of points of interest.

3. The method of claim 1, further comprising:
identifying at least one of the plurality of points of interest as a point of interest lacking relevance based on a criterion; and
sending a query to a user of the representation associated with the location what to do with the at least one of the plurality of points of interest as a point of interest lacking relevance.

4. The method of claim 1, further comprising:
indicating graphical control element for the subset on a graphical user interface; and
providing, on the graphical user interface, at least one interface for interacting with one of the plurality of points of interest or the subset of the plurality of points of interest.

5. The method of claim 1, further comprising indicating graphical control element for the subset.

6. A method comprising:
identifying a plurality of entities associated with a location within a physical environment;
generating a representation for a subset of the plurality of entities based on a feature of the entities included in the subset; and
causing a user interface, including the representation, to be rendered on a display of a wearable device.

7. The method of claim 6, wherein
the plurality of entities include a plurality of conversations,
identifying the plurality of entities includes performing speech-to-text transcription of audio captured from the physical environment, and
the feature is a topic of conversation determined by applying a model configured to process language to transcribed text from the audio.

8. The method of claim 6, further comprising:
modifying a level of detail of the representation based on a physical distance from a user;
receiving a user input selecting the representation; and
in response to the user input, causing a display of a more detailed representation of the entities included in the subset.

9. The method of claim 6, wherein
the user interface is displayed on a head-worn device,
the representation is a graphical element overlaid on a view of the physical environment, and
the representation is positioned on the display to spatially correspond to the location of the subset.

10. The method of claim 6, wherein
identifying the plurality of entities includes capturing ambient audio from the physical environment, performing source localization to distinguish between a plurality of speakers, and
clustering the plurality of speakers into distinct conversation groups, wherein the distinct conversation groups correspond to one of the plurality of entities.

11. The method of claim 6, wherein
the entities are points of interest on a map,
the representation is a graphical element indicating a quantity of the points of interest in the subset, and the method further comprising:
identifying a subset of the plurality of entities as not relevant based on an accessibility criterion; and
occluding the subset of entities from the user interface.

12. The method of claim 6, further comprising:
receiving a voice command comprising a language query from a user;
identifying a filter criterion from the language query; and
updating the user interface to display the representation for the subset of the plurality of entities that matches the filter criterion.

13. The method of claim 6, further comprising:
identifying user context data, wherein the user context data includes at least one of a calendar event, a time of day, or a user location history;
determining the feature of the entities based on the user context data; and
generating the representation as a language summary that incorporates the user context data.

14. The method of claim 6, wherein
the location is a digital information space,
the plurality of entities are digital assets within the digital information space, and
the feature is a topic shared by a plurality of the digital assets.

15. A non-transitory computer-readable storage medium comprising instructions stored thereon that, when executed by at least one processor, are configured to cause a computing system to:
identify a plurality of entities associated with a location within a physical environment;
generate a representation for a subset of the plurality of entities based on a feature of the entities included in the subset; and
cause a user interface, including the representation, to be rendered on a display of a wearable device.

16. The non-transitory computer-readable storage medium of claim 15, wherein the instructions are further configured to cause the computing system to:
modify a level of detail of the representation based on a physical distance from a user;
receive a user input selecting the representation; and
in response to the user input, cause a display of a more detailed representation of the entities included in the subset.

17. The non-transitory computer-readable storage medium of claim 15, wherein the instructions are further configured to cause the computing system to:
receive a voice command comprising a language query from a user;
identify a filter criterion from the language query; and
update the user interface to display the representation for the subset of the plurality of entities that matches the filter criterion.

18. The non-transitory computer-readable storage medium of claim 15, wherein
the plurality of entities include a plurality of conversations,
identifying the plurality of entities includes performing speech-to-text transcription of audio captured from the physical environment, and
the feature is a topic of conversation determined by applying a model configured to process language to transcribed text from the audio.

19. The non-transitory computer-readable storage medium of claim 15, wherein
identifying the plurality of entities includes capturing ambient audio from the physical environment, performing source localization to distinguish between a plurality of speakers, and
clustering the plurality of speakers into distinct conversation groups, wherein the distinct conversation groups correspond to one of the plurality of entities.

20. The non-transitory computer-readable storage medium of claim 15, wherein
the entities are points of interest on a map,
the representation is a graphical element indicating a quantity of the points of interest in the subset, and the instructions are further configured to cause the computing system to:
identify a subset of the plurality of entities as not relevant based on an accessibility criterion; and
occlude the subset of entities from the user interface.
